(19) United States
(12) Patent Application Publication
(10) Pub. No.: US 2006/0130546 A1
(43) Pub. Date: Jun. 22, 2006

(54) Methods for improving crop growth

(76) Inventors: William Beaton, Melbourne (AU); Charles William Douglas Blandy, Canterbury (AU)

Correspondence Address: MARSH, FISCHMANN & BREYFOGLE LLP, 3151 SOUTH VAUGHN WAY, SUITE 411, AURORA, CO, 80014, US

(21) Appl. No.: 10/534,517

(22) PCT Filed: Nov. 21, 2003
(86) PCT No.: PCT/AU03/01559

§ 371 Date: Oct. 24, 2005

(30) Foreign Application Priority Data
Nov. 21, 2002 (AU) 2002952857
Feb. 26, 2003 (AU) 2003900867

(51) Int. Cl. C05F 11/02

(52) U.S. Cl. 71/24

(57) ABSTRACT

A method for producing a fertilizer containing organics is described. The method comprises the steps of: a) industrially processing organic material biologically to form an activated sludge or a humus like material; b) removing water from the humus like material to form a synthetic humus and a first intermediate water stream; and c) forming the synthetic humus into agglomerates wherein the agglomerates are suitable for transportation and large scale application as a fertilizer. The method allows the production of organic fertilizers on an industrial scale and allows the products produced by the method to be utilised in composing green waste.

### FIELD OF THE INVENTION

The present invention is directed to methods for improving crop growth. More particularly but not exclusively the invention is directed to improvements in the production and application of combined organic-inorganic fertilizers. Still more particularly, the invention is directed to integrated systems for the production and application of combined organic-inorganic fertilizers.

### BACKGROUND OF THE INVENTION

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

Farming practices such as ploughing and excessive applications of inorganic fertilizers in various parts of the world are such as to deplete the organic carbon content of the soils, and most importantly to deplete the humus content of the soils.

According to Grace (Australian Journal of Experimental Agriculture 35 857-64) and Heenan (Australian journal of Experimental Agriculture 35 877-84), there has been a significant decline in soil carbon in Australian agricultural soils over the last 70-100 years. Favourable effects of reversing such a reduction in soil organic carbon include: increased microbial biomass [Chan (Australian Journal of Soil Research 30 71-83)]; increased micro-aggregates [Tisdal journal of Soil Science 33 141-63), Skjemstad (Australian Journal of Soil Research 21 539-47 and 28 267-76)]; increased erosion resistance [Carter Australian Journal of Soil Research 30 505-16)]; increased cation exchange capacity (Kapland (Agronomy Journal 77 735-8), Chan(Australian Journal of Soil Research 30 71-83)]; increased fluvic acid, humic acid and polysaccharides [Boyle(Journal of Production Agriculture 2 290-99)]; increased carbohydrates, amino acids and aliphatic to aromatic carbon ratio [Arshad (Soil Biology and Biochemistry 22 595-99)]; decreased phenolic acids [Suflita(Soil Science of America Journal 45 297-302)]; decreased aluminium toxicity [Ahmad (Soil Science of America Journal 50 656-61), Hue((Soil Science of America Journal 50 28-34)]; and increased aluminium complexes with organic acids [Bartlet (Soil Science 114 194-200), Suthipradit(Plant and Soil 124 233-7)].

Angus et al (Proceedings of 10^{th} Australian Agronomy Conference, Hobart, 2001) have recorded the decline in organic carbon in Australian soils since 1860 and estimated the loss in grain yield when growing wheat that can be attributed to this decline. They also showed that the loss of yield due to decreasing soil carbon has been at least compensated for by changing agricultural practices such as: the use of superphosphate, the use of nitrogenating crops in rotation, the use of lime to counter soil acidity arising from other changes in agricultural practice, improved weed control, and improved cultivars.

However, some of these changes have had adverse effects on long-term soil quality. Also various inorganic fertilizers are poorly retained in soils (particularly carbon depleted soils) and this results in nutrient run-off which is both wasteful in terms of fertilizer utilisation and harmful to receiving waters. Furthermore, the effects of restoring soil carbon levels and of other improvements in agricultural practice are substantially additive. According to Angus et al, restoring soil carbon levels to their levels in 1860 and continuing with other improvements in agricultural practice would result in an increase in wheat yield from a current 2.5 t grain/ha to about 4 t grain/ha.

Although the application of organic fertilizers such as compost and animal manure is well known for domestic use and small scale farming, it has not hitherto been practical in broadacre agriculture because of the cost of transport and its physical form, which makes its dispensation difficult.

Different organic products have different efficacies when used as fertilizers as is seen from the following data in which the ‘C index’ is 100 times the % increase in crop yield divided by the application rate of fertilizer expressed in kg of organic carbon per hectare:

| | | | | C index |
|---|---|---|---|---|
| | Application | | | (% increase in |
| | rate as C (%) | % crop | | yield/unit of |
| Fertiliser | (kg/ha) | response | crop | C × 10⁻²) |
| Activated Sludge | 600 | 21.1 | Tomatoes | 3.5 |
| Material | | | | |
| Wheat straw | 4200 | 30.0 | Wheat | 0.7 |
| Pelletised poultry | 1470 | 7.0 | Wheat | 0.5 |
| manure | | | | |
| Bovine manure | 50,000 | 35.0 | Wheat | 0.1 |
| composted | | | | |
| Pig litter (30%) | 840 | 15.0 | Wheat | 1.8 |
| Composted Green | 4500 | 20.0 | Lettuce | 0.4 |
| waste + grease | | | | |
| trap sludge | | | | |
| Earthworm casts | 400 | 0 | Vines | 0 |

Furthermore, it is known that if an organic fertilizer is applied below the surface of the soil, the contained carbon will be used more effectively than if it is applied to the surface of the soil. It is believed that atmospheric oxidation is responsible for the low effectiveness of surface applied organic carbon. Some forms of organic material cannot be readily applied below the surface of the soil.

For example, large amounts of green waste are produced in the process of growing commercial crops such as wheat, barley, cotton and rice. These green wastes are generally rich in carbon, nitrogen, potassium, phosphate and calcium nutrients and in certain trace elements. It would be desirable to return at least part of these nutrients to the soil and to so enrich the soil and reduce inorganic fertilizer costs.

One method of processing green waste is by composting, wherein the organic material in solid waste is broken down by micro-organisms in the presence of oxygen to a point where it can be conveniently stored, handled and applied to the environment. Composting is usually impractical on a large scale because of the difficulties in providing starter materials, an appropriate source of water and/or warm air.

### OBJECT OF THE INVENTION

The present invention is intended to provide an alternative means of improving crop growth and producing fertilizers containing organics in a manner which permits enhancement of the fuel and fertilizer potential of the feed to the process. The present invention is also intended to provide an improved method of composing vegetative material such as green waste.

### SUMMARY OF THE INVENTION

According to a first aspect of the present invention there is provided a method for improving crop growth, the method comprising the steps of:
a) establishing the soil and climatic conditions where the crop is to be grown; and
b) producing a blended fertiliser in response to the data established in step a).

According to another aspect the invention provides a method for improving crop growth, the method comprising the steps of
a) establishing the soil and climatic conditions where the crop is to be grown;
b) producing a blended fertilizer by:
   (i) industrially processing organic material biologically to form an activated sludge or a humus like material;
   (ii) removing water from the humus like material to form a synthetic humus;
   (iii) blending the synthetic humus with an inorganic fertilizer, the quantity and content of the inorganic fertilizer being dictated by the soil and climatic conditions established in step a), to produce a blended fertilizer having a suitable nutrient content for crop growth;
   (iv) forming the blended fertilizer into agglomerates that are suitable for transportation and large scale application as a fertilizer, and
c) applying the agglomerates to the soil.

In another aspect the invention provides a method for improving crop growth, the method comprising the steps of:
a) establishing the soil and climatic conditions where the crop is to be grown;
b) mixing a humus concentrate with one or more additives in response to the data established from step a), to produce a fertilizer;
c) applying the fertilizer to the soil.

In another aspect the invention provides a method for producing a fertilizer containing organics, including the steps of:
a) processing organic material biologically to form an activated sludge or a humus like material;
b) removing sufficient water from the humus like material from step a) to facilitate processing, handling and transport to form a synthetic humus and a first intermediate water stream;
c) forming the synthetic humus into agglomerates,
   wherein the agglomerates are suitable for transportation and large scale application as a fertilizer.

These steps provide the basic form of the process and additional steps may conveniently be undertaken to provide further benefits.

It has been observed that previous technology used to produce bulked up organic fertilizer from activated sludge has not been capable of providing a product suitable for economic long distance transport, nor has it been fully integrated, and as a result has produced large quantities of by-product waters which are rich in nitrogenous materials which can only be used as a fertizer if there is an agricultural site conveniently close. This has largely restricted use of previous technology to the construction of local plants in or dose to rural areas.

Typically at least part of the organic material will be solid or contain solids.

The organic material may include vegetable waste, other food waste, green waste and/or faecal material which is preferably pre-treated to remove inorganic material such as grit prior to processing step (a).

According to one typical embodiment of the invention, the organic material is tested for contaminants which might be detrimental to the operation of the process or to the use of the product, and portions of the organic waste found to have excessive levels of such contaminants are not fed into the process.

According to another preferred form of the invention, at least part of the organic material is in the form of a slurry or a suspension in an aqueous phase which is subjected to a separation process to form a thickened organic material which may be fed to step a) and a second intermediate water stream. The separation process may be undertaken by any convenient means, such as screening, sedimentation, filtration or centrifugation. Typically the separation will be by flotation, more preferably by dissolved air flotation and most preferably by high rate dissolved air flotation.

In a preferred embodiment the process for biologically forming the humus like material from organic material is anaerobic digestion. Typically the anaerobic digester will have at least two stages. Typically at least a portion of any gases generated during anaerobic digestion will be collected. Preferably, in addition to the humus like material, a third intermediate water stream will also be removed from the anaerobic digestion stage.

According to one preferred form of the invention, a bulking material may be added to the synthetic humus before its use as a fertizer. Typical bulking materials suitable for use in the present invention include peat, sawdust, coal dust, brown coal fines, lignite fines or some similar material.

The synthetic humus may be combined with one or more other fertilizers prior to use. Preferably the other fertilizers are each rich in one or more of nitrogen, potassium, phosphorous, calcium or sulphur or provide one or more trace elements. Typical examples of other fertilizers are inorganic or urea. In one preferred form of the process, the other fertilizers are added prior to or during a stage in which the synthetic humus is formed into agglomerates.

In a more preferred form of the invention, the agglomerates have a size, degree of compaction and/or binding agent such that the rate of release of nutrients from the agglomerates is suited to the crop, the soil and the growing conditions envisaged. Optionally, agglomerates having different nutrient release rates can be adapted to suit cropping regimes which require a rapid initial release of some nutrients followed by a slower release of the same and/or other nutrients.

According to a preferred form of the invention, the relative proportions of synthetic humus and various other fertilizers are determined to give combined fertilizers having:
particular required relative proportions of nutrient components (such as, but not limited to, organic carbon, and compounds of nitrogen, phosphorous and potassium); and/or
required balance of fast-release and slow-release forms of a particular nutrient; and/or
required proportion of materials for adjusting soil pH (e.g. lime); wherein
   the relative proportions of nutrient compounds, the balance of fast-release and slow-release forms and/or the proportion of soil adjusting materials are determined to suit the intended use of the combined fertilizer.

Typical factors considered in determining the required composition of a combined fertilizer will include one or more of: the chemistry of the soil to which the combined fertilizer is to be applied, the crop which is to be grown in the soil, and the climate where the soil is situated.

According to another preferred form of the invention, at least part of the intermediate water streams are subjected to treatment to increase the purity of the water. According to a more preferred form of the invention, the treatment of the intermediate water stream(s) also produces a concentrate which is enriched in the nutrients contained in the intermediate water stream(s) and which is capable of use as a liquid fertilizer. Preferably, the treatment of the intermediate waste water is by one or more of: reverse osmosis, distillation and freeze concentration. The first, second and third intermediate waste water streams may be treated together or separately, or may be subjected to a process whereby they are treated separately for some part(s) of the process and together for other part(s) of the process.

In particular, the concentrate derived from the second intermediate water stream may be rich in nitrogenous material, especially if material such as animal waste is processed. In another preferred form of the invention, at least part of this concentrate is combined with synthetic humus and optionally other fertilizers to form combined fertilizers as described herein.

According to another preferred form of the invention, the solids content of the material being processed at various stages is adjusted by adding water to the process at or before those stages. Preferably at least part of the water used will be provided from the intermediate water streams wherein such water may be untreated, partly treated and/or fully treated.

According to another preferred form of the invention, at least part of the gases generated during the anaerobic digestion are burnt to generate energy and waste gases containing carbon dioxide. Preferably a part of this energy is used to generate electricity. Preferably a part of the energy is used to supply the energy requirements of the treatment of the intermediate water stream(s). More preferably part of the energy is used to generate electricity and the residual waste heat from the electricity generation is used to supply at least part of the energy requirements of the treatment of the intermediate water stream(s).

Further, in a preferred form of the invention, at least part of the waste gases would be applied to beneath the surface of soil, preferably by means of perforated or permeable conduits placed beneath the surface of the soil. Additionally or alternatively, at least part of the carbon dioxide in the waste gases may be dissolved in water such as an intermediate water stream, preferably under pressure to form a carbonated water. Alkaline material such as waste lime may be added to the carbonated water. The carbonated water may be separated, preferably by a membrane process to produce a purer water stream and a concentrate. The concentrate may be combined with the synthetic humus and optionally other fertilizers as described below.

Another form of the invention provides a fertilizer containing organic material manufactured according to one or more of the forms of the invention described herein.

According to one typically preferred form of the invention, the fertilizer containing organic material comprises synthetic humus manufactured according to one or more of the forms of the invention summarised above combined with a bulking material. Preferably the bulking material is peat, sawdust, coal dust, brown coal fines, lignite fines or some similar material.

According to another preferred form of the invention, the fertilizer containing organic material comprises synthetic humus manufactured according to one or more of the forms of the invention summarised above combined with one or more other fertilizers. Typically the other fertilizers are each rich in one or more of nitrogen, potassium, phosphorous, calcium or sulphur or provide one or more trace elements. Typical examples of other fertilizers include inorganic fertilizers or urea.

According to another form of the invention there is provided a method for encouraging the growth of crops whereby a fertilizer containing organic material according to one or more of the forms of the invention described herein or manufactured according to one or more of the forms of the invention described herein is applied to soil in which plants are to be grown or in which plants are growing

According to a preferred form of the invention, at least part of the fertilizer containing organic material is applied below the surface of the soil. Preferably most of the fertilizer containing organic material is applied below the surface of the soil.

According to another preferred form of the invention, the fertilizer containing organic material is applied on or below the surface of the soil and a bulking material such as peat, sawdust, coal dust, brown coal fines, lignite fines or some similar material is applied on top of the soil and the fertilizer containing organic material.

According to another form of the invention there is provided a method for producing combined fertilizers comprising the following steps:
a) analysing the soil on which the crops are to be grown;
b) establishing the geographical location where the crops are to be grown and/or the climatic conditions at the geographic location at which the crops are to be grown;
c) establishing what crop is to be grown on the soil and/or the nutrient requirements of the crop;
d) entering the data obtained into a computer which also contains a database and a computer program, wherein the database contains information on at least one of:
   i. the nutrient requirements of various crops, optionally both short and long term requirements;
   ii. the nutrient requirements of the soil, optionally both short and long term requirements;
   iii. the effect of climate on the nutrient requirements of various crops;
   iv. the effect of soil quality on the nutrient requirements of various is crops;
   v. the soil pH requirements of various crops;
   vi. the climatic conditions at various locations where crops might be grown;
   vii. the costs, chemical compositions and nutrient contents of various fertilizers;
   viii. the rates of release of nutrients in various fertilizers;
   ix. the effects of agglomerate form on rates of release of nutrients in various fertilizers;
   x. the effects on soil pH of various fertilizers;
   xi. transport costs to various locations;
   xii. the availability and cost of bulking materials at various locations, and
      the computer program is capable of retrieving information from the database to determine the nutrient requirements for the particular cropping situation and of calculating the blend of fertilizers required to form a combined fertilizer and the application rate of combined fertilizer which is expected to provide the nutrient needs at the lowest cost;
e) calculating the quantity of combined fertilizer to be manufactured and the selling price;
f) optionally, the quantity and price of combined fertilizer is communicated to the potential customer (if any) for confirmation of an order and if the order is not confirmed the remaining steps are not performed;
g) blending the required fertilizers in the proportions determined in step d) and the quantity determined in step e).
   Preferably, the combined fertilizer will be converted into agglomerates and placed in suitable containers which are marked to denote its intended use.

According to a preferred form of the invention, the combined fertilizer will include an organic fertilizer. The combined fertilizer will typically include synthetic humus. Preferably the synthetic humus is made according to one or more of the processes described herein.

The present invention accordingly provides a range of fertilizers which may be particularly useful for reversing or preventing carbon depletion of soils, a method of manufacturing such fertilizers, and a system for tailoring fertilizers for particular uses. In some of its forms the invention can be operated so that there are substantially no liquid discharges and substantially no gaseous discharges except products of combustion.

Some activated sludge derived materials according to the subject of the present invention are unusual in being: effective organic fertilizers, suitable for sub soil application, suitable for relatively long distance transport, applicable for broadacre and other agricultural use and capable of production in large quantities.

In use, organic material (typically organic waste) is received and tested for unacceptable levels of contaminants. If the contaminant levels are acceptable the organic material is fed to the process.

Depending on the nature of the organic material, it may be desirable to include steps for the removal of potential contaminants such as grit and/or other inactive solids. The stage at which this is done, and the method used to effect it will depend on the nature of the organic material, for example for piggery waste grit may be removed by sedimentation, before the waste is concentrated.

Any portion of the organic material which is in the form of slurry or suspension may be subjected to a concentration process. Examples of such material include piggery waste, restaurant food waste and potato processing plant waste. The most suitable method of concentration will depend on the nature of the organic waste, and may include filtration, pressure filtration, sedimentation or screening. However flotation and particularly high density dissolved air flotation are often particularly suitable.

In addition to a concentrated organic material this process produces an aqueous stream (a second intermediate water stream as described herein) which will commonly be rich in nutrients. If the organic material includes animal waste, the nutrients will include nitrogenous compounds. This nutrient rich aqueous stream cannot be discharged to receiving waters, but is too dilute to be economically used as a fertilizer except in areas close to the processing plant. In some forms of the present invention at least part of the nutrient rich aqueous stream(s) is subjected to a treatment process which may be a separation process to produce a concentrated nutrient fraction, which may be used as a liquid fertilizer either separately or mixed into the agglomerated fertilizer, and an aqueous stream of sufficient purity for discharge or other use. The separation process may include one or more of distillation, freeze concentration and membrane processes such as reverse osmosis.

The organic material and/or concentrated organic material is then subjected to a biological process to convert it to activated sludge or some other humus like form. The biological process may be anaerobic digestion, and typically a two-stage anaerobic digestion. Preferably a two-stage process is used in which the first stage is operated at an elevated temperature and the second stage operates at a lower temperature than the first stage in a manner which facilitates the inactivation or death of at least some of the biological agents. However, it will be appreciated by those skilled in the art that any other process which results in an organic product suitable for use as a plant nutrient may be used.

In addition to the humus like material, the biological process may produce gases and/or an aqueous stream.

If anaerobic digestion or a similar process is used, the gases will usually contain significant quantities of methane. Discharge of these gases to the atmosphere would contribute to the greenhouse effect. Therefore, it is desirable to burn the gases and this has the added benefit of permitting recovery of their energy values. It may be desirable to remove some of the impurities from the gases prior to their combustion in order to reduce corrosion of equipment and emissions to the atmosphere.

Energy from the combustion of the gases may be recovered as electricity and/or heat, and preferably both are recovered. Combustion of the gases may be in equipment such as an internal combustion engine, a gas turbine, a fuel cell or a combustion chamber which may be associated with steam generation or the heating of a heat transfer fluid. It may be convenient to use heat recovered from the combustion of the gases to provide part or all of the energy for the separation process(es) for the intermediate water stream(s) and/or to provide heat for the warm stage of the anaerobic digestion process.

If there is conveniently located agricultural land, part or all of the combustion gases, and preferably after recovery of heat from them, may be conducted beneath the surface of the soil by means such as permeable or perforated pipes, and permitted to permeate the soil. This provides warmth, carbon dioxide (and in some cases moisture due to condensation of water vapour in the combustion gases) to the region where plant roots are growing. It may also be convenient to use the same distribution system for the application of irrigation water and/or liquid fertilizer.

Alternatively or additionally, at least part of the carbon dioxide in the combustion gases may be dissolved in a water stream, preferably one of the intermediate water streams, to form a carbonated stream. This is most readily achieved by contacting the gas and the water at elevated pressure. Advantageously, alkaline material may be added to the water before, during or after its contact with the gas. A suitable source of alkaline material may be lime or slaked lime which has been used as an absorbant or neutralising agent but still retains some activity.

The carbonated stream may then be concentrated, preferably by one or more membrane separation processes, to produce a less concentrated aqueous stream and a concentrate. This concentrate will contain most of the carbon dioxide, preferably bound with an alkaline material, and any nutrients in the carbonated stream. At least part of this concentrate may be blended with synthetic humus as herein described and may then contribute to the calcium content of the blended material.

The aqueous stream from the biological process (third intermediate stream) will be contaminated and will usually contain nutrients. It may be convenient to subject the third intermediate water stream to treatment. In general the methods of treatment may be as already described above for the second intermediate water stream. It may be convenient to use a common process for at least part of the treatment of the second intermediate and the third intermediate water streams.

The activated sludge or other humus like material produced by the biological process may contain substantial quantities of water. It is convenient to reduce the quantity of this water to create a synthetic humus before further processing. Methods for reducing this water may include one or more of: sedimentation, filtration, pressing or, preferably, centrifugation and/or reverse osmosis. This step will also generate an aqueous stream (the first intermediate water stream) which will be contaminated and will usually contain nutrients. It may be convenient to subject the first intermediate water stream to treatment. In general the methods of treatment may be as already described above for the second intermediate water stream. It may be convenient to use a common process for at least part of the treatment of the first intermediate water stream, the second intermediate water stream and/or the third intermediate water stream.

It will often be required to add water at one or more stages in the process. For example, water addition may be required to adjust the solids concentration in the high density dissolved air flotation (if used) or in the anaerobic digester (if used). Conveniently, this water may be derived from one or more of the intermediate water streams, and it may be added to the process in its untreated, partly treated or fully treated form or in some convenient combination of these.

In some cases it will be found convenient to alter the nature of the activated sludge or other humus like material either prior to or during the water removal process, so as to facilitate the water removal process. This alteration may include the addition of flocculants or drainage aids, or modifications, such as a partial oxidation of the surface, to make the material less hydrophilic.

At least part of the synthetic humus may be blended with a bulking material such as peat, sawdust, coal dust, brown coal fines or lignite fines. The blended material may then be dried and/or packaged for use as a fertiliser.

At least part of the synthetic humus may be blended with urea and/or inorganic fertilizers to produce a material with the required relative proportions of nutrients (such as organically available carbon, nitrogen, phosphorous and potassium). It may be desirable to form the blended material into agglomerates by means of suitable equipment which may include, but is not limited to, pan or drum pelletisers, pug mills or pin mixers.

The equipment used for agglomeration may the same or separate from that used for blending. Depending on the process used to form the agglomerates it may be desirable to at least partially dry the synthetic humus prior to the blending and/or agglomerating step(s), and/or to recycle some of the product from the agglomeration stage, optionally after it has been at least partially dried, into the blending and/or agglomeration step(s). The blended material may then be dried and/or packaged for use as a fertiliser, preferably by application below the surface of the soil.

A preferred means of use of the invention is to integrate it into a method to permit more effective use of fertilizers. This means would involve a person, usually the user of the fertilizer, providing information on one or more of: the area to be cropped, the crop to be grown, the geographical location or the climatic conditions of the land on which the crop is to be grown, and either soil samples or the results of soil analysis of the land on which the crop is to be grown.

If soil samples are provided, these will be analysed to give information on the soil type and soil chemistry. If the geographical location of the land is provided, this will be used to determine climatic conditions at that location.

A computer system is used in which is stored information about nutrient requirements of various types of crop grown under and preferably including the effects of climatic conditions and/or soil types. From this information the computer calculates the quantity of blended fertilizer required, the appropriate relative proportions of the various nutrient factors in the blended fertilizer and, preferably, the quantities of synthetic humus, urea and/or inorganic fertilizers to be included in the blended fertilizer for cost-effective production. Optionally there is then provision for the purchaser or potential user of the blended fertilizer to confirm that the blended fertilizer is required.

The various components are then blended in the required proportions and quantity in the process as already described and the product is identified for its intended use. This product identification will usually be by means of packaging the blended fertilizer and applying some form of identifier (readable by humans or by machine) to the package. Preferably the blending, packaging and identification marking process will all be instigated and/or controlled by the computer system.

According to another aspect of the present invention there is provided a method for composting vegetative material such as green waste wherein composting is facilitated by the addition of at least one product which is derived from the anaerobic digestion of organic material wherein said product may be: humus, microorganisms, water, nitrogenous nutrient or hot gas and is produced by carrying out the steps of the method according to the first aspect of the invention.

Preferably the vegetative material is shredded, comminuted and/or micronised before it is composted.

According to a preferred form of the invention, vegetative material is combined with one or more soils and preferably with a humus product. Preferably the vegetative material is in layers which are interspersed with layers of soil and/or humus. Preferably the soil(s) are nutrient rich. In a preferred form of the invention the humus is derived from the anaerobic digestion of organic material.

According to another preferred form of the invention, a water stream is added to the composting material as required to maintain its moisture content within a range which is conducive to the composting process. Preferably the water stream is derived from the anaerobic digestion process. More preferably it is a water stream which is rich in nitrogen.

According to another preferred form of the invention, hot gas is introduced to the composting material as required to maintain its temperature within a range which is conducive to the composting process. Preferably the hot gas is derived from the anaerobic digestion process. Conveniently, the hot gas may be the product of combustion of biogas generated from the anaerobic digesters and/or air heated by the combustion of biogas.

According to a more preferred form of the invention, the composting material is periodically tested to determine the required amount of hot gas, water and/or nitrogenous material to be added.

According to another form of the invention there is provided a compost made according to any of the previously described methods. The compost may be pelletised, compacted and/or coated prior to use.

According to another preferred form of the invention, at least part of the compost according to the invention is combined with synthetic humus according the first aspect of the invention to form a combined product. The combined product may be pelletised, compacted and/or coated. Preferably the combined product will also incorporate urea and/or inorganic fertilizers.

According to a particularly preferred form of the invention there is provided a process for producing compost from vegetative material for use as a feedstock in producing a combined fertilizer comprising:
reducing the size of the green waste by means such as comminution, shredding and/or micronising; and
composting the green waste of reduced size in the presence of soil and at least one product which is derived from the anaerobic digestion of organic material wherein said product may be: humus, microorganisms, water, nitrogenous nutrient or hot gas
   whereby to produce a compost suitable for mixing with synthetic humus and/or inorganic fertilizer and/or urea.

Preferably, at least part of the compost or combined product is applied below the surface of the soil.

It will be apparent that the micro-organisms which participate in the composting process may originate from one or more of: the vegetative waste, the humus product, the water stream, or another source associated with the process according to the first aspect of the invention.

### DESCRIPTION OF THE DRAWINGS

The invention will now be further explained and illustrated by reference to the accompanying drawings of a non-limiting example in which:

FIG. 1 is a flow diagram of a process for the manufacture of organic and blended fertilizers according to one form of the invention;

FIG. 2 is a flow diagram of a process for the production of a compost product that utilises the by-products of the process illustrated in FIG. 1 and is agglomerated with the blended fertilizer.

Organic material in the form of organic wastes 10 is received from suppliers. The waste may include such items as food waste from restaurants, wholesalers and retailers; piggery and feed-lot waste and agricultural residues from farms or food processors. These organic wastes are placed in appropriate storage 20. The type of storage will depend on the nature of the organic waste, for example pumpable materials such as piggery wastes will be placed in tanks; fine solids, such as oat husks, or solids likely to give offensive odours, such as food waste, are placed in silos; other wastes may be placed on concrete slabs.

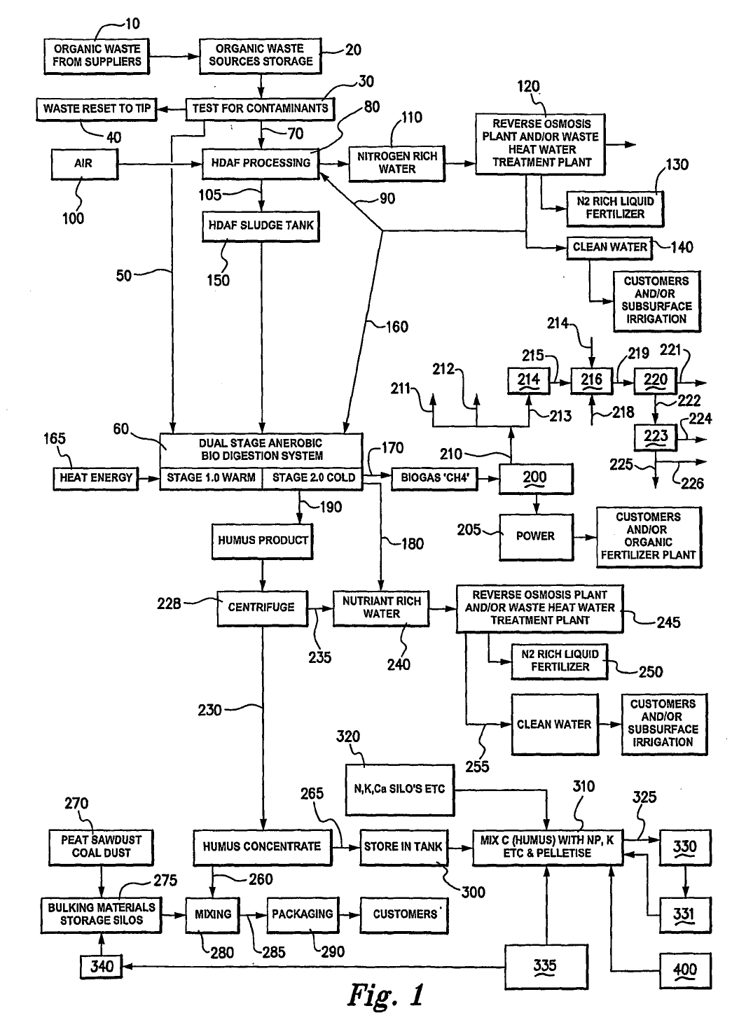

Samples of the waste are tested periodically for contaminants 30, either on removal from storage (as shown in FIG. 1) or on receipt (not shown). Testing is for levels of contaminants which would be detrimental to the process (e.g. materials which would be pathogenic to the anaerobic digestion process) or to the fertilizer product (e.g. heavy metals). Materials found to have unacceptable contaminant levels are sent to a waste tip 40.

Organic waste of substantially solid nature 50 may be sent to an anaerobic digestion system 60. Depending on the nature of the organic waste it may be desirable to include facilities (not shown) to reduce the size of particles of organic waste and/or to remove unwanted material such as tramp metal.

Organic waste in the form of slurries or suspensions of material, and particularly if it contains substantial concentrations of dissolved nutrients, 70 is sent to a High Rate Dissolved Air Flotation (HDAF) step 80. In this step treated water 90 is added as required to bring the concentration of dissolved solids to the optimum range for the operation of the process. Air 100 is fed into the step in a manner which produces small bubbles many of which become attached to the suspended solid particles thus tending to cause them to become buoyant. This results in most of the suspended solids floating to the surface from whence it is removed as a sludge 105, and a second intermediate water stream 110 is drawn off from the bottom of the HDAF step. This intermediate water stream will usually contain dissolved solids including nutrients, and depending on the nature of the organic waste from which it is derived, it will often be particularly rich in nitrogen.

Optionally, the second intermediate water stream will be subjected to removal of most of the remaining suspended solids by a suitable means such as a sand filter or membrane filtration (not shown). It is then subjected to treatment 120 to concentrate most of the dissolved solids into a first aqueous stream which may be used as a liquid fertilizer 130 and a second aqueous stream of substantially clean water 140 which may be used for concentration control in other stages of the process, for irrigation, or for other purposes appropriate to its level of purity. The treatment 120 is by means of reverse osmosis and/or distillation. The electrical power for the reverse osmosis and at least part of the heat for the distillation is derived from the combustion of gases from the anaerobic digestion stage as discussed below.

The sludge 105 from the HDAF step is fed to a HDAF Sludge Tank 150 for storage, and thence to the anaerobic digestion system 60. Recycled water 160 is added to the anaerobic digestion system as required to maintain operation at dose to the optimum solids concentration. A two-stage anaerobic digestion system is used wherein the first stage operates at a somewhat elevated temperature selected to facilitate optimum growth of the anaerobic organisms (a temperature in or about the range 35-45° C. is often suitable) and the second stage operates at different temperature to kill or inactivate most of the anaerobic organisms (often reducing the temperature to near ambient is appropriate, in other cases it may be more effective to increase the temperature).

The temperature of the first stage is selected to facilitate the biological process and/or to inactivate pathogens. Generally a heat input 165 will be required to achieve the elevated temperature in the first stage. This may be achieved by supplying hot water from the distillation step in water treatment 120 and/or waste gases from the combustion of gases derived from the anaerobic digester.

Three streams are drawn off from the anaerobic digester: a gas 170, a second intermediate water stream 180 and a sludge or humus like material 190.

The gas 170 is rich in methane and has a substantial fuel value. It will usually contain sulphur compounds which may be removed by scrubbing (not shown). The gases are then burned in a combined-cycle combustion unit 200 to give electrical power 205, carbon dioxide containing gases 210 and thermal energy. Some of the electrical power is used to supply the needs of the process, the remainder is sold or used in an associated inorganic fertilizer plant as appropriate. The thermal energy is used for distillation in water treatment and to supply heat input into the anaerobic digester.

Some of the carbon dioxide containing gases 210 are vented to atmosphere 211, and another portion 212 is conducted to sub-soil porous tubes (not shown) which may also be used for irrigation and for the application of liquid fertilizer. The remainder of the carbon dioxide containing gases 213 are compressed 214 to form a pressurised gas 215.

The pressurised gas is introduced into a gas dissolver 216 into which water 217 (preferably substantially clean water 140 from water treatment 120) and alkali 218 (preferably partially used lime or slaked lime) are also introduced. In the gas dissolver 216 most of the carbon dioxide will dissolve in the water 140, with the dissolution process facilitated by the pressure and the presence of alkali 218, but most of the nitrogen and oxygen will not dissolve. The gas dissolver product 219 is fed to a gas separator 220 (which may conveniently be a cyclone or a disengagement drum) wherein most of the undissolved gases 221 are collected and vented to the atmosphere, and the liquid phase is collected as a carbonated liquor 222.

The carbonated liquor 222 is fed into a carbonated liquor concentration unit 223, which may conveniently include a solids filter and a reverse osmosis separator to produce a lean aqueous stream 224 and a carbonate concentrate 225. The lean aqueous stream 224 consists of comparatively dean water and may be re-used in the plant, used for irrigation or discharged. The carbonate concentrate 225 is a liquor, slurry or paste containing most of the dissolved carbon dioxide and most of the alkali 218 (usually reacted to form an inorganic carbonate, particularly calcium bicarbonate).

Preferably at least part of the carbonate concentrate 225 is used as required as a source of alkali in the production of blended product 325 as described below. Its use in blended products is particularly relevant for use on acid soils. Any carbonated concentrate surplus to the requirements for the production of blended product 226 may be sold or disposed of separately and it is preferably used as agricultural lime.

The sludge or humus like material 190 is fed to a centrifuge 228 which produces humus concentrate or synthetic humus 230 and a first intermediate water stream which is combined with the third intermediate water stream 180 to form a nutrient rich water stream 240.

Optionally, the nutrient rich water stream will be subjected to removal of most of the remaining suspended solids by a suitable means such as a sand filter or membrane filtration (not shown). It is then subjected to treatment 245 to concentrate most of the dissolved solids into a third aqueous stream which may be used as a liquid fertilizer 250 and a fourth aqueous stream of substantially dean water 255 which may be used for concentration control in other stages of the process, for irrigation, or for other purposes appropriate to its level of purity. The treatment 245 is by means of reverse osmosis and/or distillation. The electrical power for the reverse osmosis and at least part of the heat for the distillation is derived from the combustion of gases from the anaerobic digestion stage.

The synthetic humus may be split into two streams: a blending fraction 265 and, if it is required to produce a bulked product, a bulking fraction 260.

Bulking materials 270 in the form of peat, sawdust and coal dust are placed in storage silos from whence they are fed into a mixing stage 280 where they are mixed with the synthetic humus 260 to form a bulked product 285. The mixing unit may take any convenient form, such as a pug mill. The bulked product may optionally be passed through a drying stage (not shown) and is then packaged 290 prior to dispatch to customers.

The blending fraction of the synthetic humus 265 is stored in a tank or silo 300 and then fed into a mixing and pelletising unit 310 into which urea and/or inorganic fertilizers 320 are also fed, to produce a blended product 325. The mixing and pelletizing unit may include a pug mixer, a drum pelletizer and, optionally, a dryer. The blended product may be packaged (not shown) prior to dispatch to customers for placement 330 to optimise crop growth and soil condition. The blended product is particularly effective if it is applied below the surface of the soil.

After the blended product has been applied to the soil and the crops are grown, the soil and climatic conditions can again be determined (331). This data is then used as an input to the mixing/pelletising unit to produce a blended product that is suited to the particular site on which the crops are gown. The information loop of application of blended fertilizer, crop growth, establishment of soil and climatic conditions and subsequent tailoring of blended fertilizer may continue through as many iterations as required.

A compost product 400 may also be fed into the mixing/pelletising unit 310 together with the synthetic humus 265, urea and/or inorganic fertilizer(s) 320 to produce the blended product 325.

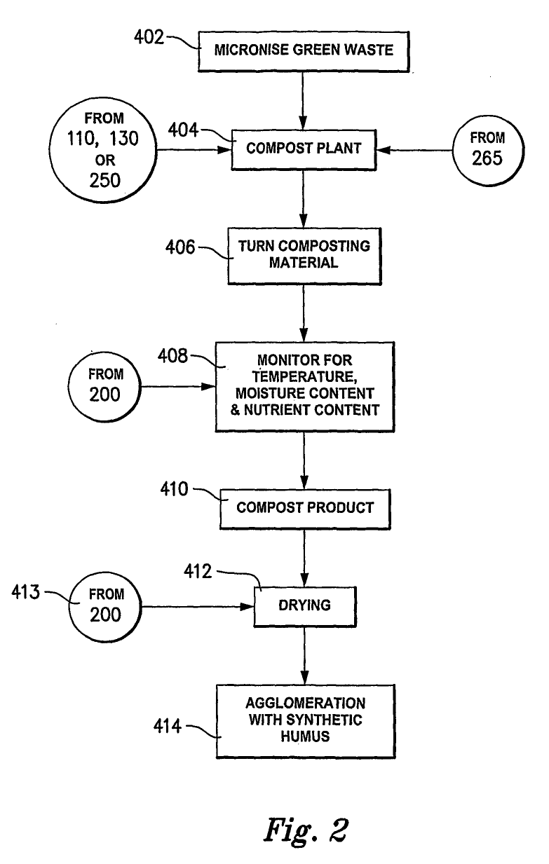

As shown in FIG. 2 the compost product may be produced utilising by-products of the process described above. Green waste which is typically in the form of straw, chaff and/or non-marketable portions of crop plants, is micronised (402) or other-wise reduced in size and introduced (464) to a compost plant which typically operates at about 100-200° F. (ca 35-95° C.). Soil and, preferably, humus or synthetic humus is also introduced to the compost plant in a manner such that it is either in alternate layers with the green waste or mixed with the green waste.

The compost plant can be of any convenient form. Preferably, the compost plant should permit the composting material to be turned (406). Benefits of turning may include: homogenisation of the compost, more uniform exposure to air and more uniform moisture content. One preferred arrangement is the use of multiple bins whereby the composting material may be turned in the bins and moved along the bins as the composting process proceeds.

The composting material is monitored (408) at suitable intervals for temperature, moisture content and optionally for nutrient content. As required hot air or other gas, and water, both derived from the synthetic humus plant, are introduced to the compost plant to increase the temperature and moisture content respectively of the composting material. Nitrogen rich water from the synthetic humus plant may be used when appropriate.

Typically the composting process will take 2 weeks to 6 months to complete. The time required will depend on such factors as the type of green waste being composted and the composting temperature. At the end of this period a compost product is produced (410).

The moisture content of the compost product may be reduced by drying (412) or partial drying by a suitable means. Sources of heat for the drying process may be derived from the synthetic humus plant, e.g. heat arising from the combustion of the biogas (413). Conveniently drying may be performed at about 150-180° F. (ca65-85° C.).

As required for the particular application, the compost product may be agglomerated (414) in the mixing/pelleting unit 310, with humus from the synthetic humus plant, inorganic fertilizer(s), urea and/or a bulking agent to form a blended product. The blended product may also be agglomerated by being compacted, pelletised and/or coated to provide a convenient form for handling and application.

The manufacturing system is integrated into a business system whereby:
(i) A computer system 335 is used which contains data on: climatic conditions in regions where the blended product is to be sold; nutrient requirements of various types of crops under various climatic conditions; and cost, composition and nutrient release characteristics of the synthetic humus, urea and various inorganic fertilizers available to the manufacturing facility
(ii) Enquiries are received from a potential purchaser containing details of: crop to be grown, geographic location of where crop is to be grown, area to be cropped, and analysis of soil to be cropped or one or more samples of the soil.
(iii) If soil sample(s) are supplied they are analysed to give details of the soil properties.
(iv) Information from steps ii and iii are entered into the computer system 335 which calculates the optimum fertilizer composition; the relative proportions of synthetic humus, urea and inorganic fertilizer components to produce this fertilizer at minimum cost; the quantity of fertilizer to be produced; the price for which the fertilizer will be sold; and, optionally the expected date of manufacture.
(v) This information is communicated to the potential purchaser.
(vi) If the potential purchaser confirms the order, the computer system 335 transmits the relevant details to a manufacturing computer system 340 which is used for scheduling and controlling the mixing and blending unit.
(vii) At the appropriate time (as determined by the scheduling function of the system), the required quantity of fertilizer of the required composition is made, packed and the packages marked to indicate the customer and order details.
(viii) The product is dispatched.

### EXAMPLES

The effectiveness of the fertilizer products described in this invention is illustrated by the following non-limiting example. Tomatoes were grown on a series of adjacent plots of sandy soil, and were provided with fertilizers of various types. The yield of tomatoes per plot was measured. The results of the trials are summarised in Table 1.

It is apparent from this example that the fertilizers containing synthetic humus are more effective than poultry manure or than inorganic fertilizer used alone. Furthermore, the fertilizers containing synthetic humus and inorganic fertilizers is even more effective than synthetic humus alone. The effectiveness of the invention according to this application is even more pronounced when the fertilizers are compared on the basis of the increase in crop yield compared with the control divided by cost of fertilizer used.

Further still, it will be noted that in addition to providing only limited increase in yield, the inorganic fertilizer does not contribute to soil carbon replacement. Therefore its continued use alone would be expected to result in decreasing crop yield with time. However, the fertilizers according to this invention replenish soil carbon and are expected to provide increased yield with time.

The blended product may then be applied e.g. as a fertilizer or as a soil conditioning agent. Preferably the blended product is applied below the surface of the soil.

The word ‘comprising’ and forms of the word ‘comprising’ as used in this description does not limit the invention claimed to exclude any variants or additions.

Modifications and improvements to the invention will be readily apparent to those skilled in the art. Such modifications and improvements are intended to be within the scope of this invention.

TABLE 1

| | | | | Yield | Carbon | % | | | | | |
|---|---|---|---|---|---|---|---|---|---|---|---|
| | | Weight/ha in | Tomato Yield | increase | Weight | By weight | | | Cost/ha | C | Cost |
| No | Fertilizer Mix | kgs | kg/plot | % | kg/ha | N | P | K | $/ha | Index³ | benef⁴ |
| 1 | ASM 200 kg/ha + | 2300 | 12.51 | 39.3 | 880 | 4.4 | 5.3 | 5.0 | 280 | 4.5 | 14.0 |
| | Pivot 800 at 300 kg/ha | | | | | | | | | | |
| 2 | ASM blended with | 2000 | 11.26 | 25.4 | 900 | 4.0 | 4.4 | 4.0 | 300 | 2.9 | 8.5 |
| | inorganic fertilizers | | | | | | | | | | |
| 3 | ASM | 4000 | 10.99 | 22.4 | 1760 | 4.4 | 4.4 | 4.4 | 320 | 1.3 | 7.0 |
| 4 | Synthetic humus + | 1300 + 120 | 10.33 | 15.0 | 507 | 3.9 | 3.9 | 6.6 | 320 | 3.0 | 4.7 |
| | muriated potash | | | | | | | | | | |
| 5 | Poultry manure | 1300 | 9.05 | 0.8 | 520 | 3.9 | 3.6 | 2.0 | 390 | 0.15 | 0.21 |
| 6 | Pivot 800 | 500 | 9.04 | 0.7 | nil | 4.0 | 5.5 | 5.0 | 200 | — | 0.35 |
| 7 | Control (no fertilizer) | — | 8.98 | — | nil | nil | nil | nil | nil | — | — |

¹Note:
All tests except control were dosed with trace elements and given a slide-dress of 80 kg [kg/ha?] of Ammonium Nitrate
²Note:
ASM mix costs about A$75/tonn plus $20 freight and Spreading Costs. ASM consists of 33% Synthetic humus 66% of bulking agents (pine bark, brown coal dust)
³C index is % increase of yield/application rate kg C/ha × 100
⁴Cost benefit is % increase of yield/fertilisation cost × 100

1. A method for improving crop growth, the method comprising the steps of:
a) establishing the soil and climatic conditions where the crop is to be grown; and
b) producing a blended fertiliser in response to the data established in step a).

2. A method for improving crop growth, the method comprising the steps of:
a) establishing the soil and climatic conditions where the crop is to be grown;
b) producing a blended fertilizer by:
(i) industrially processing organic material biologically to form an activated sludge or a humus like material;
(ii) removing water from the humus like material to form a synthetic humus;
(iii) blending the synthetic humus with an inorganic fertilizer, the quantity and content of the inorganic fertilizer being dictated by the soil and climatic conditions established in step a), to produce a blended fertilizer having a suitable nutrient content for crop growth;
(iv) forming the blended fertilizer into agglomerates that are suitable for transportation and large scale application as a fertilizer, and
c) applying the agglomerates to the soil.

3. A method according to claim 2 and further including the steps of establishing at least the soil conditions after the agglomerates have been applied to the soil and repeating steps b) and c).

4. A method according to claim 2, wherein the nutrients are any one or more of carbon, nitrogen, phosphorous and potassium.

5. A method according to claim 2, wherein the relative proportions of synthetic humus and inorganic fertilizer are such that the blended fertilizer includes a fast release form and a slow release form of a particular nutrient.

6. A method according to claim 2, wherein the relative proportions of synthetic humus and inorganic fertilizer are such that the blended fertilizer has the required proportion of materials to adjust soil pH.

7. A method according to claim 2, wherein the physical characteristics of the agglomerates are such that nutrients are released from the agglomerates at different rates.

8. A method according to claim 7, wherein the physical characteristics include any one or more of size, degree of compaction and presence of a binding agent.

9. A method according to claim 2, and further including the step of combining the synthetic humus with a bulking material either before or during the step of forming the synthetic humus into agglomerates to produce a bulked fertilizer.

10. A method according to claim 2 wherein the biological processing is by way of anerobic digestion.

11. A method according to claim 2, wherein the step of removing water from the humus like material includes the step of partially oxidising the surface of the humus like material to make the material less hydrophilic.

12. A method for composing vegetative material such as green waste, the method including the step of adding at least one product which is derived from the anaerobic digestion of organic material, wherein such product may be humus, micro-organisms, water, nitrogenous nutrient or hot gas and is derived by carrying out the steps of the method according to claim 2.

13. A method according to claim 12, and further including the step of combining the compost with the synthetic humus either before or during the step of forming the synthetic humus into agglomerates to produce a blended fertilizer.

14. A method for improving crop growth, the method comprising the steps of:
a) establishing the soil and climatic conditions where the crop is to be grown;
b) mixing a humus concentrate with one or more additives in response to the data established from step a), to produce a fertilizer;
c) applying the fertilizer to the soil.

15. A method according to claim 14, wherein said additive is a bulking material.

16. A method according to claim 14, wherein said additive is one or more plant nutrients.

17. A method for improving crop growth, the method comprising:
(a) analysing the soil on which the crop is to be grown;
(b) establishing the geographical location where the crop is to be grown and/or the climatic conditions at the geographic location at which the crop is to be grown;
(c) establishing what crop is to be grown on the soil and/or the nutrient requirements of the crop;
(d) entering the data obtained into a computer which also contains a database and a computer program, wherein the database contains information on at least one of:
the nutrient requirements of various crops, optionally both short and long term requirements;
the nutrient requirements of the soil, optionally both short and long term requirements;
the effect of climate on the nutrient requirements of various crops;
the effect of soil quality on the nutrient requirements of various crops;
the soil pH requirements of various crops;
the climatic conditions at various locations where crops might be grown;
the costs, chemical compositions and nutrient contents of various fertilizers;
the rates of release of nutrients in various fertilizers;
the effects of agglomerate form on rates of release of nutrients in various fertilizers;
the effects on soil pH of various fertilizers;
transport costs to various locations;
the availability and cost of bulking materials at various locations, and the computer program is capable of retrieving information from the database to determine the nutrient requirements for the particular cropping situation and of calculating the blend of fertilizers required to form a combined fertilizer and the application rate of combined fertilizer which is expected to provide the nutrient needs at the lowest cost;
(e) calculating the quantity of combined fertilizer to be manufactured and the selling price;
(f) optionally, the quantity and price of combined fertilizer is communicated to the potential customer (if any) for confirmation of an order and if the order is not confirmed the remaining steps are not performed; and
(g) producing said combined fertilizer as required.

18. A method for producing combined fertilizers, the method comprising:
(a) analysing the soil on which the crops are to be grown;
(b) establishing the geographical location where the crops are to be grown and/or the climatic conditions at the geographic location at which the crops are to be grown;
(c) establishing what crop is to be grown on the soil and/or the nutrient requirements of the crop;
(d) entering the data obtained into a computer which also contains a database and a computer program, wherein the database contains information on at least one of:
the nutrient requirements of various crops, optionally both short and long term requirements;
the nutrient requirements of the soil, optionally both short and long term requirements;
the effect of climate on the nutrient requirements of various crops;
the effect of soil quality on the nutrient requirements of various crops;
the soil pH requirements of various crops;
the climatic conditions at various locations where crops might be grown;
the costs, chemical compositions and nutrient contents of various fertilizers;
the rates of release of nutrients in various fertilizers;
the effects of agglomerate form on rates of release of nutrients in various fertilizers;
the effects on soil pH of various fertilizers;
transport costs to various locations;
the availability and cost of bulking materials at various locations, and
the computer program is capable of retrieving information from the database to determine the nutrient requirements for the particular cropping situation and of calculating the blend of fertilizers required to form a combined fertilizer and the application rate of combined fertilizer which is expected to provide the nutrient needs at the lowest cost;
(e) calculating the quantity of combined fertilizer to be manufactured and the selling price;
(f) optionally, the quantity and price of combined fertilizer is communicated to the potential customer (if any) for confirmation of an order and if the order is not confirmed the remaining steps are not performed;
(g) blending the required fertilizers in the proportions determined in step d) and the quantity determined in step e).

19. A method for producing a fertilizer containing organics, the method comprising the steps of:
a) industrially processing organic material biologically to form an activated sludge or a humus like material;
b) removing water from the humus like material to form a synthetic humus and a first intermediate water stream; and
c) forming the synthetic humus into agglomerates, wherein the agglomerates are suitable for transportation and large scale application as a fertilizer.

20. A method according to claim 19, and further including the step of combining the synthetic humus with an inorganic fertilizer either before or during the step of forming the synthetic humus into agglomerates, to produce a blended fertilizer.

21. A method according to claim 20, wherein the relative proportions of synthetic humus and inorganic fertilizer are such that the blended fertilizer has a predetermined quantity of one or more nutrients.

22. A method according to claim 21, wherein the nutrients are any one or more of organic carbon, nitrogen, phosphorous and potassium.

23. A method according to claim 20, wherein the relative proportions of synthetic humus and inorganic fertilizer are such that the blended fertilizer includes a fast release form and a slow release form of a particular nutrient.

24. A method according to claim 20, wherein the relative proportions of synthetic humus and inorganic fertilizer are such that the blended fertilizer has the required proportion of materials to adjust soil pH.

25. A method according to claim 19, wherein the physical characteristics of the agglomerates are such that the rate of release of nutrients from the agglomerates are suited to a particular crop, soil and/or growing condition.

26. A method according to claim 19, wherein the physical characteristics of the agglomerates are such that nutrients are released from the agglomerates at different rates.

27. A method according to claim 25, wherein the physical characteristics include any one or more of size, degree of compaction and presence of a binding agent.

28. A method according to claim 19, and further including the step of combining the synthetic humus with a bulking material either before or during the step of forming the synthetic humus into agglomerates to produce a bulked fertilizer.

29. A method according to claim 19, and further including the steps of:
d) separating the organic material into a sludge and a second intermediate water stream, the sludge being the input to step a);
e) separating the second intermediate water stream into a fist aqueous stream of dissolved solids and a second aqueous stream of substantially clean water wherein the first aqueous water stream is suitable for use as a liquid fertilizer.

30. A method according to claim 29, and further including the step of utilising the second aqueous stream during step a).

31. A method according to claim 19, and further including the steps of:
f) burning gas produced during step a) to produce a carbon dioxide containing gas;
g) dissolving carbon dioxide from the carbon dioxide containing gas to form a carbonated liquor;
h) separating a carbonate concentrate from the carbonate liquor; and
i) combining at least some of the carbonate concentrate with the synthetic humus either before or during the step of forming the synthetic humus into agglomerates.

32. A method according to claim 19, and further including the step of separating the first intermediate water stream into a third aqueous stream of dissolved solids and a fourth aqueous stream of substantially clean water wherein the third aqueous stream is suitable for use as liquid fertilizer.

33. A method according to claim 32, and further including the step of utilising the fourth aqueous water stream during step a).

34. A method according to claim 19, wherein the step of removing water from the humus like material includes the step of adding a flocculant or a drainage aid to the humus like material.

35. A method according to claim 19, wherein the step of removing water from the humus like material includes the step of partially oxidising the surface of the humus like material to make the material less hydrophilic.

36. A method for composing vegetative material such as green waste, the method including the step of adding at least one product which is derived from the anaerobic digestion of organic material, wherein such product may be humus, micro-organisms, water, nitrogenous nutrient or hot gas and is derived by carrying out the steps of the method according to claim 2.

37. A method according to claim 36, and further including the step of combining the compost with the synthetic humus either before or during the step of forming the synthetic humus into agglomerates to produce a blended fertilizer.
